(19) United States
(12) Patent Application Publication
(10) Pub. No.: US 2025/0332982 A1
(43) Pub. Date: Oct. 30, 2025

(54) Multiway Cargo Net Device

(71) Applicant: Kevin Younger, Hutto, TX (US)

(72) Inventor: Kevin Younger, Hutto, TX (US)

(21) Appl. No.: 19/171,531

(22) Filed: Apr. 7, 2025

Related U.S. Application Data
(60) Provisional application No. 63/637,906, filed on Apr. 24, 2024.

(51) Int. Cl. B60P 7/08

(52) U.S. Cl. CPC B60P 7/0876

(57) ABSTRACT

An adjustable cargo net device is disclosed which comprises a net component that is configured in a rectangular base shape with attaching horizontal and vertical rows. The horizontal and vertical rows are adjustable by the overhand knot which connects them. Further, the overhand knot allows the rope to be slid to the right or left to adjust each square. Thus, the net component is relatively strong and adjustable. The device is also comprised of brightly colored ropes to allow for more visibility at night. Further, the net component comprises a fixed outer perimeter to easily secure the device to the vehicle. The end of each rope may also be torched to prevent fraying or other damage to the net component.

### CROSS-REFERENCE TO RELATED APPLICATION

The present application claims priority to, and the benefit of, U.S. Provisional Application No. 63/637,906, which was filed on Apr. 24, 2024, and is incorporated herein by reference in its entirety.

### FIELD OF THE INVENTION

The present invention relates generally to the field of adjustable cargo net devices. More specifically, the present invention relates to a multipurpose cargo net which can secure any size or shape item. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in adjustable cargo net devices. Generally, transporting different types of cargo in pickup trucks, vans, SUVs, and other vehicles can be incredibly difficult when trying to tie down cargo of various sizes. Some boxes and containers may be larger than others. Accordingly, ropes and bungees used to keep these larger boxes cannot be used to simultaneously secure smaller or oddly shaped boxes. Further, a solution is needed for people to transport their cargo safely and securely with the same devices.

Accordingly, a cargo net constructed in accordance with the invention can be easily adjusted to fit around different sized and shaped items as desired. Further, it is often necessary for people to secure multiple different types of items in their vehicle while transporting them. This would typically cause multiple different cords and ropes to secure everything in place. Accordingly, users must be very careful about how each separate cord and/or rope is secured, leaving room for error in many ways.

Accordingly, there is a demand for an improved adjustable cargo net device that allows users to secure multiple different items of various sizes, configurations, and shapes. More particularly, there is a demand for an adjustable cargo net device that users can slide the ropes of the net around to adjust them.

Therefore, there exists a long felt need in the art for an adjustable cargo net device that provides users with a multipurpose cargo net for securing any shape, size, or configuration of item in truck beds, vans, SUVs, and more. There is also a long felt need in the art for an adjustable cargo net device that features multiple knots arranged in rows that can be placed and manually adjusted over cargo pieces to keep them secure. Further, there is a long felt need in the art for an adjustable cargo net device that enables users to completely adjust the net to fit around boxes and other oddly shaped items to ensure they remain secure and do not move around during transport. Moreover, there is a long felt need in the art for a device that utilizes red, blue, and yellow colors on the rope to make the rope more visible, especially during lowlight hours of the day. Further, there is a long felt need in the art for an adjustable cargo net device that provides a double-braided rope to ensure that the device is strong enough for all types of transport. Finally, there is a long felt need in the art for an adjustable cargo net device that includes a fixed outer perimeter for more secure handling.

The subject matter disclosed and claimed herein, in one embodiment thereof, comprises an adjustable cargo net device. The device is a modified cargo net with adjustable ropes that can be shifted or tightened as needed. The adjustable cargo net device comprises a net component that is configured in a rectangular base shape with attaching horizontal and vertical rows. The horizontal and vertical rows are adjustable by the overhand knot which connects them. Further, the overhand knot allows the rope to be slid to the right or left to adjust each square. Thus, the net component is relatively strong and adjustable. The device is also comprised of brightly colored ropes to allow for more visibility at night. Further, the net component comprises a fixed outer perimeter to easily secure the device to the vehicle. The end of each rope may also be torched to prevent fraying or other damage to the net component.

In this manner, the adjustable cargo net device of the present invention accomplishes all of the forgoing objectives and provides users with a device that provides an adjustable cargo net for securing different sizes and shapes of cargo. The device is a cargo net with adjustable vertical and horizontal ropes. The device can comprise a plurality of bright colors.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adjustable cargo net device. The device is a modified cargo net with adjustable ropes that can be shifted or tightened as needed. The adjustable cargo net device comprises a net component that is configured in a rectangular base shape with attaching horizontal and vertical rows. The horizontal and vertical rows are adjustable by the overhand knot which connects them. Further, the overhand knot allows the rope to be slid to the right or left to adjust each square.

In one embodiment, the adjustable cargo net device allows users to adjust the size and shape of the cargo net to secure unwieldy objects. Further, the cargo net can be adjusted by an overhand knot which slides left or right. Accordingly, users can manipulate the cargo net (i.e., moving, adjusting, sliding, etc.), solely via the overhand knot, saving users significant time and energy and preventing pain and discomfort.

In one embodiment, the adjustable cargo net device comprises a net component that is configured in rectangular shape. The net component comprises an outer perimeter with 6 horizontal and 6 vertical sections of rope. However, the net component can be any suitable shape and size as is known in the art, as long as the net component is sized and shaped to be secured to a truck bed or specifically whatever vehicle is being used for transport.

In one embodiment, the net component is adjustable through the sliding of rope through overhand knots which connect the horizontal and vertical sections of rope. The overhand knot is secured to the different sections and allows for the rope to be slid either to the left or the right, effectively repositioning the squares created by the horizontal and vertical sections of rope as well as the size.

In one embodiment, the overhand knot is utilized when adjusting and moving the device over items of various shapes and sizes. Further, the overhand knot can be comprised of any suitable rope as is known in the art, as long as the overhand knot allows a user to securely and comfortably manipulate the device with their hands. Additionally, the adjustable cargo net device comprises 24 specific overhand knots to connect every horizontal and vertical section of rope.

In one embodiment, the net component is comprised of 0.375 inch double-braided rope to ensure that it is strong enough to withstand the elements as well as hold certain heavier items in place. Further, the color of the rope of the net component is typically red, blue, yellow, or a combination of all three so as to appear vibrant in order to be seen at night.

In one embodiment, the tail ends of all ropes used to form the net component are cropped with a torch to keep the rope from fraying or unraveling completely. The torch ends include the tail ends of every knot used.

In one embodiment, the net component comprises an outer perimeter which is fixed in place and cannot be adjusted. This outer perimeter contains four designated loops on the corners to allow the outer perimeter to be secured to the vehicle. This outer perimeter is joined together with two sliding slip knots on both ends of the rope which makes up the outer perimeter. Typically, the rope passes through the eye of the slip knot and then creates the second slip knot which effectively slides the two pieces of rope together; pulling it tight allows them to be secured.

In one embodiment, the six horizontal and six vertical sections of rope need to be longer than the rope that comprises the outer perimeter to offset the knots which will be secured to the outer perimeter of the net component with the creation of the 24 overhand knots with the sections being looped through twice for each knot to ensure security.

In one embodiment, the adjustable cargo net device contains 60 total knots among it with 28 of those knots being stationary, 24 of which secure the six horizontal and six vertical rows.

In one embodiment, the adjustable cargo net device is manufactured from nylon, polyester, polypropylene, high-performance fibers, or other suitable materials as is known in the art, or a combination of such materials.

In yet another embodiment, the adjustable cargo net device comprises a plurality of indicia.

In yet another embodiment, a method of adjusting a cargo net over unwieldy objects is disclosed. The method includes the steps of providing an adjustable cargo net device comprising a net component with horizontal and vertical sections of braided rope. The method also comprises securing the outer perimeter to the vehicle by the four designated loops. Further, the method comprises placing the device over the objects which need to be secured. The method also comprises adjusting the device by sliding the rope around the overhand knot left or right to comfortably fit each object underneath. Finally, the method comprises transporting the items without worry.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the adjustable cargo net device of the present invention showing the horizontal and vertical sections of rope along with the overhand knots in accordance with the disclosed architecture;

FIG. 2 illustrates a perspective view of one embodiment of the adjustable cargo net device of the present invention showing the device in use in accordance with the disclosed architecture; and

FIG. 3 illustrates a flowchart showing the method of adjusting a cargo net over unwieldy objects in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an adjustable cargo net device that provides users with a multipurpose cargo net for securing any shape, size, or configuration of item in truck beds, vans, SUVs, and more. There is also a long felt need in the art for an adjustable cargo net device that features multiple knots arranged in rows that can be placed and manually adjusted over cargo pieces to keep them secure. Further, there is a long felt need in the art for an adjustable cargo net device that enables users to completely adjust the net to fit around boxes and other oddly shaped items to ensure they remain secure and do not move around during transport. Moreover, there is a long felt need in the art for a device that utilizes red, blue, and yellow colors on the rope to make the rope more visible, especially during lowlight hours of the day. Further, there is a long felt need in the art for an adjustable cargo net device that provides a double-braided rope to ensure that the device is strong enough for all types of transport. Finally, there is a long felt need in the art for an adjustable cargo net device that includes a fixed outer perimeter for more secure handling.

The present invention, in one exemplary embodiment, is a novel adjustable cargo net device. The adjustable cargo net device comprises a net component that is configured in a rectangular base shape with attaching horizontal and vertical rows. The horizontal and vertical rows are adjustable by the overhand knot which connects them. Further, the overhand knot allows the rope to be slid to the right or left to adjust each square. Thus, the net component is relatively strong and adjustable. The device is also comprised of brightly colored ropes to allow for more visibility at night. Further, the net component comprises a fixed outer perimeter to easily secure the device to the vehicle. The present invention also includes a novel method of adjusting a cargo net over unwieldy objects. The method includes the steps of providing an adjustable cargo net device comprising a net component with horizontal and vertical sections of braided rope. The method also comprises securing the outer perimeter to the vehicle by the four designated loops. Further, the method comprises placing the device over the objects which need to be secured. The method also comprises adjusting the device by sliding the rope around the overhand knot left or right to comfortably fit each object underneath. Finally, the method comprises transporting the items without worry.

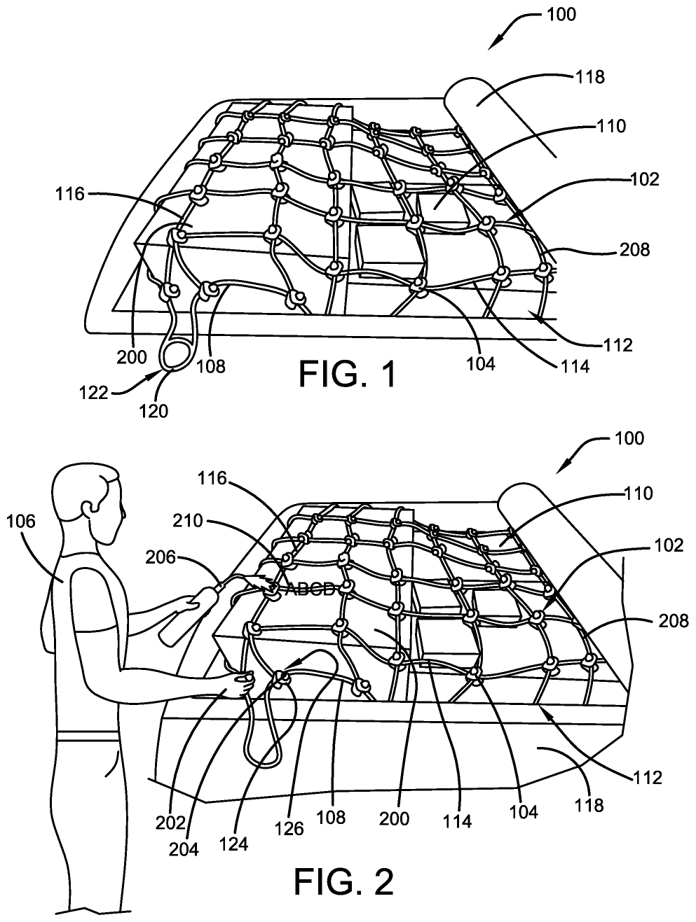

Referring initially to the drawings, FIG. 1 illustrates a perspective view of one embodiment of the adjustable cargo net device 100 of the present invention. In the present embodiment, the adjustable cargo net device 100 is an improved adjustable cargo net device 100 that provides a user 106 with a cargo net which is adjustable by sliding ropes to adjust the shape and size of the squares. Specifically, the adjustable cargo net device 100 comprises a net component 102 and an overhand knot 104. Thus, the net component 102 is strong and adjustable via the overhand knot 104. Further, the overhand knot 104 remains stationary and allows the ropes 108 which comprise the net component 102 to slide left or right, thus adjusting the net component 102.

Generally, the adjustable cargo net device 100 allows users 106 to adjust the size and shape of the net component 102 to secure unwieldy objects 110. Further, the net component 102 can be adjusted by an overhand knot 104 which allows the ropes 108 to slide left or right. Accordingly, users 106 can manipulate the net component 102 (i.e., moving, adjusting, sliding, etc.), solely via sliding the ropes 108, saving users 106 significant time and energy and preventing pain and discomfort.

Additionally, the adjustable cargo net device 100 comprises a net component 102 that is configured in rectangular shape. The net component 102 comprises an outer perimeter 112 with 6 horizontal 114 and 6 vertical sections of rope 116. However, the net component 102 can be any suitable shape and size as is known in the art, as long as the net component 102 is sized and shaped to be secured to a truck bed 118 or specifically whatever vehicle is being used for transport.

Further, the net component 102 comprises an outer perimeter 112 which is fixed in place and cannot be adjusted. This outer perimeter 112 contains four designated loops 120 on the corners 122 to allow the outer perimeter 112 to be secured to the vehicle 118. This outer perimeter 112 is joined together with two sliding slip knots 124 on both ends of the rope 108 which makes up the outer perimeter 112. Typically, the rope 108 passes through the eye 126 of the slip knot 124 and then creates the second slip knot 124 which effectively slides the two pieces of rope 108 together; pulling it tight, allowing them to be secured.

Additionally, the six horizontal 114 and six vertical sections 116 of rope 108 need to be longer than the rope 108 that comprises the outer perimeter 112 to offset the slip knots 124 which will be secured to the outer perimeter 112 of the net component 102 with the creation of 24 overhand knots 104 with the sections being looped through twice for each knot to ensure security.

As seen in FIG. 2, the net component 102 is adjustable through the sliding of rope 108 through overhand knots 104 which connect the horizontal 114 and vertical sections 116 of rope 108. The overhand knot 104 is secured to both the horizontal 114 and vertical sections 116 and allows for the rope 108 to be slid either to the left or the right, effectively repositioning the squares 200 created by the horizontal 114 and vertical sections 116 of rope 108 as well as the size of the squares 200.

Further, the overhand knot 104 is utilized when adjusting and moving the device 100 over objects 110 of various shapes and sizes. Additionally, the overhand knot 104 can be comprised of any suitable rope 108 as is known in the art, as long as the overhand knot 104 allows a user 106 to securely and comfortably manipulate the device 100 with their hands 202. Furthermore, the adjustable cargo net device 100 comprises 24 specific overhand knots 104 to connect every horizontal 114 and vertical section 116 of rope 108. This allows for the adjustable cargo net device 100 to contain 60 total knots among it with 28 of those knots being stationary.

Generally, the net component 102 is comprised of 0.375 inch double-braided rope 108 to ensure that it is strong enough to withstand the elements as well as hold certain heavier objects 110 in place. Further, the color of the rope 108 of the net component 102 is typically red, blue, yellow, or a combination of all three, so as to appear vibrant in order to be seen at night.

Additionally, the tail ends 204 of all ropes 108 used to form the net component 102 are cropped with a torch 206 to keep the rope 108 from fraying or unraveling completely. The tail ends 204 include the ends of every knot used.

Further, the adjustable cargo net device 100 is manufactured from nylon, polyester, polypropylene, high-performance fibers, or other suitable materials 208 as is known in the art, or a combination of such materials 208.

In yet another embodiment, the adjustable cargo net device 100 comprises a plurality of indicia 210. The net component 102 of the device 100 may include advertising, a trademark, or other letters, designs, or characters, printed, painted, stamped, or integrated into the net component 102, or any other indicia 210 as is known in the art. Specifically, any suitable indicia 210 as is known in the art can be included, such as but not limited to, patterns, logos, emblems, images, symbols, designs, letters, words, characters, animals, advertisements, brands, etc., that may or may not be cargo net, adjustable rope, or brand related.

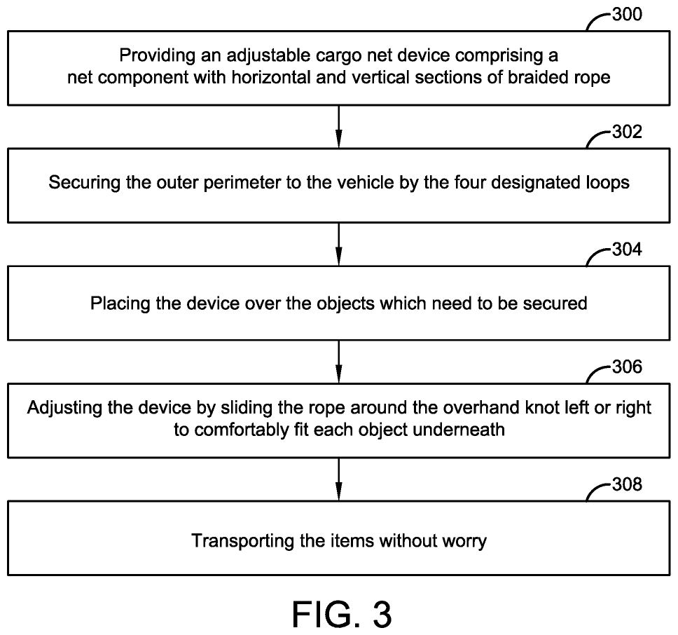

FIG. 3 illustrates a flowchart of the method of adjusting a cargo net over unwieldy objects. The method includes the steps of at 300, providing an adjustable cargo net device comprising a net component with horizontal and vertical sections of braided rope. The method also comprises at 302, securing the outer perimeter to the vehicle by the four designated loops. Further, the method comprises at 304, placing the device over the objects which need to be secured. The method also comprises at 306, adjusting the device by sliding the rope around the overhand knot left or right to comfortably fit each object underneath. Finally, the method comprises at 308, transporting the items without worry.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “adjustable cargo net device”, “cargo net device”, “adjustable rope device”, and “device” are interchangeable and refer to the adjustable cargo net device 100 of the present invention.

Notwithstanding the foregoing, the adjustable cargo net device 100 of the present invention can be of any suitable size and configuration as is known in the art without affecting the overall concept of the invention, provided that it accomplishes the above stated objectives. One of ordinary skill in the art will appreciate that the adjustable cargo net device 100 as shown in FIGS. 1-3 is for illustrative purposes only, and that many other sizes and shapes of the adjustable cargo net device 100 are well within the scope of the present disclosure. Although the dimensions of the adjustable cargo net device 100 are important design parameters for user convenience, the adjustable cargo net device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable cargo net device that provides a user with an adjustable cargo net designed to transport irregular objects, the adjustable cargo net device comprising:
a net component; and
a plurality of overhand knots;
wherein the plurality of overhand knots are secured to the net component and can act to manipulate the net component to move and adjust ropes of the net component as needed; and
further wherein the net component comprises a secure outer perimeter.

2. The adjustable cargo net device of claim 1, wherein the net component is configured in a rectangular base shape with a secure outer perimeter and six sections of horizontal rope crossed with six sections of vertical rope.

3. The adjustable cargo net device of claim 2, wherein the secure outer perimeter is secured to a vehicle via a series of four loops placed on corners of the secure outer perimeter.

4. The adjustable cargo net device of claim 3, wherein the secure outer perimeter is secured together via two sliding slip knots which allows the rope to be looped twice to ensure strength.

5. The adjustable cargo net device of claim 4, wherein horizontal and vertical sections of the rope are longer in length than the secure outer perimeter.

6. The adjustable cargo net device of claim 5, wherein the net component is adjustable via an overhand knot which secures the horizontal and vertical sections of the rope together and allows the rope to be slid to a left or a right in order to adjust size and shape of the net component.

7. The adjustable cargo net device of claim 6, wherein the overhand knot allows for repositioning of squares which are created by the horizontal and vertical sections of the rope to allow the squares to fit over irregular objects.

8. The adjustable cargo net device of claim 7, wherein the net component is comprised of braided rope which has a width of 0.375 inches.

9. The adjustable cargo net device of claim 8, wherein a color of the net component is typically red, blue, yellow, or a combination of all three for better visibility.

10. The adjustable cargo net device of claim 9, wherein the ropes within the net component all comprise tail ends which are torched in order to prevent fraying.

11. The adjustable cargo net device of claim 10, wherein the net component is comprised of nylon, polyester, polypropylene, high-performance fibers, or combination of such materials.

12. The adjustable cargo net device of claim 11 further comprising a plurality of indicia.

13. An adjustable cargo net device that provides a user with a cargo net manipulated by sliding sections of rope, the adjustable cargo net device comprising:
a net component configured in a rectangular shape; and
a plurality of overhand knots;
wherein the net component comprises an outer perimeter which is secured to a vehicle being used to transport cargo;
wherein the net component also comprises horizontal and vertical sections of rope which are connected by at least one of the plurality of overhand knots;
wherein the net component is adjustable via the plurality of overhand knots which allow the rope to slide to a left or right;
wherein the plurality of overhand knots allow squares of the net component which are created by overlapping horizontal and vertical sections to adjust their shape and size to fit over irregular objects; and
further wherein the plurality of overhand knots is knotted twice within the net component to ensure security.

14. The adjustable cargo net device of claim 13 further comprising a plurality of indicia.

15. The adjustable cargo net device of claim 14, wherein the outer perimeter is secured to the vehicle with four loops built into corners of the outer perimeter.

16. The adjustable cargo net device of claim 15, wherein the outer perimeter is attached to the net component via slip knots.

17. The adjustable cargo net device of claim 16, wherein all of ropes in the net component contain tail ends which are torched to prevent fraying.

18. The adjustable cargo net device of claim 17 wherein the net component is comprised of nylon, polyester, polypropylene, high-performance fibers, or a combination of such materials.

19. The adjustable cargo net device of claim 18 wherein a color of the net component is red, blue, yellow, or any combination of such colors.

20. A method of adjusting a cargo net over unwieldy objects in a vehicle, the method comprising the following steps:
providing an adjustable cargo net device comprising a net component with horizontal and vertical sections of braided rope, a set of four designated loops and an overhead knot;
securing the outer perimeter to the vehicle by the set of four designated loops;
placing the adjustable cargo net device over the unwieldy objects;
adjusting the adjustable cargo net device by sliding the braided rope around the overhand knot left or right; and
transporting the unwieldy objects.
